(19) United States
(12) Patent Application Publication
(10) Pub. No.: US 2026/0221929 A1
(43) Pub. Date: Jul. 30, 2026

(54) Supporting Assembly for Solar Panels Applied to Container Charging Station and Container Charging Station

(71) Applicant: Shenzhen Haylion Technologies Co., Ltd., Shenzhen, Guangdong (CN)

(72) Inventors: Jianping Hu, Shenzhen, Guangdong (CN); Gen Peng, Shenzhen, Guangdong (CN); Guoxi Yin, Shenzhen, Guangdong (CN); Bo Su, Shenzhen, Guangdong (CN); Yaowei Li, Shenzhen, Guangdong (CN); Rong Wu, Shenzhen, Guangdong (CN); Wanze Wu, Shenzhen, Guangdong (CN)

(21) Appl. No.: 18/720,673

(22) PCT Filed: May 25, 2023
(86) PCT No.: PCT/CN2023/096331

§ 371 Date: Jun. 17, 2024

(30) Foreign Application Priority Data
May 10, 2023 (CN) 202321114822.3

(51) Int. Cl. H02S 20/30; B60L 53/51; H02S 10/20; H02S 30/20

(52) U.S. Cl. CPC H02S 20/30; B60L 53/51; H02S 10/20; H02S 30/20

(57) ABSTRACT

The present application discloses a supporting assembly for solar panels applied to a container charging station, which includes a top plate and two cover plates movably connected to the top plate; a side surface of each of the cover plates is fixedly provided with a support; an end of the support is provided with a strip-shaped supporting rod; and a plurality of fixed rods are fixedly disposed in parallel on the supporting rod. The cover plates can be driven by jacking mechanisms to drive the supports to rotate, and thus, the solar panels are intensively stored; and after the solar panels are unfolded at the same time, rotating motors drive the supporting rods to rotate and drive the solar panels to adjust pitch angles, so that angles of the solar panels adapt to a solar irradiation angle, which maximizes power generation efficiencies of the solar panels.

### CROSS REFERENCE TO RELATED APPLICATIONS

The present application is based on Chinese patent application No. 202321114822.3 filed on May 10, 2023 and claims the priority thereof, the entire contents of which are incorporated herein by reference.

### TECHNICAL FIELD

The present application relates to the technical field of new energy, in particular to a supporting assembly for solar panels applied to a container charging station and the container charging station.

### BACKGROUND ART

With the development of new energy technology, more and more electric vehicles need to be charged in charging piles. However, traditional charging piles perform AC charging by introducing commercial power, which leads to lower charging speeds. In order to achieve intensive charging, solar panels can be disposed on appropriate positions, and electric energy generated from solar energy can be stored to perform quick charging in a DC manner. However, solar panels in existing technical methods need to be fixedly mounted in a large area, and inclination angles of the existing solar panels are usually unadjustable, which leads to less electric energy generated per unit area of the solar panels and lower power generation efficiencies. Therefore, the solar panels for power generation and energy storage in the existing technical methods have the problem of poorer power generation efficiencies.

### SUMMARY OF THE INVENTION

Embodiments of the present application provide a supporting assembly for solar panels applied to a container charging station and the container charging station, which aim at solving the problem of poorer power generation efficiencies of solar panels for power generation and energy storage in existing technical methods.

In a first aspect, an embodiment of the present application provides a supporting assembly for solar panels applied to a container charging station, wherein the supporting assembly includes a top plate and two cover plates movably connected to the top plate;
two sides in a long axis direction of the top plate are respectively rotatably connected to sides of one of the cover plates; a side surface, facing away from the top plate, of each of the cover plates is fixedly provided with a support;
an end, away from the top plate, of the support is provided with a strip-shaped supporting rod; a long side direction of the supporting rod is parallel to a long side direction of the top plate;
a plurality of fixed rods are fixedly disposed in parallel on the supporting rod; long side directions of the fixed rods are perpendicular to the long side direction of the supporting rod; the fixed rods are fixedly provided with solar panels;
a side surface, facing away from the top plate, of each of the cover plates is further provided with a jacking mechanism, and the jacking mechanisms are capable of driving the cover plates to rotate along the sides; and
ends of the supporting rods are all fixedly connected to rotating shafts disposed on the supports, the rotating shafts on at least one end of the supporting rods are driven by and connected to rotating motors, and the rotating motors are capable of driving the supporting rods to rotate and driving the solar panels to adjust pitch angles.

For the supporting assembly for the solar panels applied to the container charging station, wherein a cross section of the supporting rod is rectangular.

For the supporting assembly for the solar panels applied to the container charging station, wherein each of the fixed rods includes a horizontal fixed rod fixedly disposed on a side surface of the supporting rod and an inclined fixed rod fixedly disposed on a side surface, opposite to the horizontal fixed rod, on the supporting rod; and two ends of the inclined fixed rod are both fixedly connected to the horizontal fixed rod.

For the supporting assembly for the solar panels applied to the container charging station, wherein the rotating shafts on two ends of the supporting rod are respectively driven by and connected to one of the rotating motors.

For the supporting assembly for the solar panels applied to the container charging station, wherein an edge of a side, away from the top plate, of each of the cover plates is turned and rolled to the supporting rod to form a hemming with an “L”-shaped section.

For the supporting assembly for the solar panels applied to the container charging station, wherein the jacking mechanisms include at least two jacking air cylinders disposed on the cover plates; and
a side surface of the hemming is provided with a connecting seat in which a connecting shaft is disposed, and an end of a jacking rod in each of the jacking air cylinders is rotatably connected to the connecting shaft.

For the supporting assembly for the solar panels applied to the container charging station, wherein the supports include a plurality of first fulcrum bars perpendicular to the side surfaces of the cover plates, second fulcrum bars fixedly disposed on an end, away from the cover plates, of each of the first fulcrum bars and perpendicular to the first fulcrum bars and third fulcrum bars for connecting the first fulcrum bars and the second fulcrum bars; one of the first fulcrum bars is combined with one of the corresponding second fulcrum bars and one of the corresponding third fulcrum bars to form a triangular structure; and
the rotating shafts are disposed on connections of the second fulcrum bars and the third fulcrum bars.

For the supporting assembly for the solar panels applied to the container charging station, wherein the supports further include fourth fulcrum bars fixedly disposed on an end, close to the cover plates, of each of the first fulcrum bars and perpendicular to the first fulcrum bars and fifth fulcrum bars for connecting the fourth fulcrum bars and the first fulcrum bars; one of the first fulcrum bars is combined with one of the corresponding fourth fulcrum bars and one of the corresponding fifth fulcrum bars to form a triangular structure; and
side surfaces of the fourth fulcrum bars are fixedly connected to the side surfaces of the cover plates.

In a second aspect, an embodiment of the present application further provides a container charging station, wherein the container charging station includes the supporting assembly for the solar panels as mentioned in the first aspect and further includes a bottom plate and supporting plates disposed on two ends of the bottom plate;
the bottom plate is provided with a plurality of sets of charging piles;
two ends of the top plate are respectively fixedly connected to the two supporting plates; and when the jacking mechanisms drive the cover plates to rotate to ensure that each of the cover plates is horizontal and each of the solar panels is perpendicular, the bottom plate, the cover plates, the top plate and the solar panels are enclosed to form a closed box.

For the container charging station, wherein the supporting plate on one end is provided with a box side door which is openable and closeable.

Embodiments of the present application provide a supporting assembly for solar panels applied to a container charging station and the container charging station, wherein the supporting assembly includes a top plate and two cover plates movably connected to the top plate; two sides in a long axis direction of the top plate are respectively rotatably connected to sides of one of the cover plates; a side surface, facing away from the top plate, of each of the cover plates is fixedly provided with a support; an end, away from the top plate, of the support is provided with a strip-shaped supporting rod; a long side direction of the supporting rod is parallel to a long side direction of the top plate; a plurality of fixed rods are fixedly disposed in parallel on the supporting rod; long side directions of the fixed rods are perpendicular to the long side direction of the supporting rod; and the fixed rods are fixedly provided with solar panels. For the above-mentioned supporting assembly for the solar panels, the cover plates can be driven by jacking mechanisms to drive the supports to rotate, and thus, the solar panels are intensively stored, and the area occupied after the solar panels are stored is reduced; and after the solar panels are unfolded at the same time, rotating motors drive the supporting rods to rotate and drive the solar panels to adjust pitch angles, so that angles of the solar panels adapt to a solar irradiation angle, which maximizes power generation efficiencies of the solar panels.

### BRIEF DESCRIPTION OF THE DRAWINGS

In order to describe the technical solutions in the embodiments of the present application more clearly, the accompanying drawings required for describing the embodiments will be briefly introduced below. Obviously, the accompanying drawings in the following description show only some embodiments of the present application, and those of ordinary skill in the art may still derive other accompanying drawings from these accompanying drawings without creative work.

FIG. 1 is an overall structural diagram of a supporting assembly for solar panels provided in an embodiment of the present application;

FIG. 2 is a local structural diagram of a supporting assembly for solar panels provided in an embodiment of the present application;

FIG. 3 is a lateral structural diagram of a supporting assembly for solar panels provided in an embodiment of the present application;

FIG. 4 is another lateral structural diagram of a supporting assembly for solar panels provided in an embodiment of the present application; and

FIG. 5 is an overall structural diagram of a container charging station provided in an embodiment of the present application.

Reference numerals in the accompanying drawings: 1, top plate; 2, cover plate; 3, support; 4, supporting rod; 5, fixed rod; 10, solar panel; 6, jacking mechanism; 7, rotating shaft; 71, rotating motor; 51, horizontal fixed rod; 52, inclined fixed rod; 61, jacking air cylinder; 62, connecting seat; 63, connecting shaft; 64, jacking rod; 31, first fulcrum bar; 32, second fulcrum bar; 33, third fulcrum bar; 34, fourth fulcrum bar; 35, fifth fulcrum bar; 36, first fixed cross bar; 37, second fixed cross bar; 21, bottom plate; 22, supporting plate; 23, charging pile; and 24, box side door.

### DETAILED DESCRIPTION OF THE INVENTION

Technical solutions in the embodiments of the present application will be described clearly and completely below in conjunction with the accompanying drawings in the embodiments of the present application. Obviously, the described embodiments are only a part of the embodiments of the present application, not all the embodiments. Based on the embodiments in the present application, all other embodiments obtained by those of ordinary skill in the art without creative work shall fall within the protection scope of the present application.

It should be understood that when used in the description and the appended claims, terms “including” and “includes” indicate the presence of described features, entireties, steps, operations, elements and/or components, but do not exclude the presence or addition of one or more other features, entireties, steps, operations, elements, components and/or sets thereof.

It should also be understood that the terms used in the description of the present application are only for the purpose of describing specific embodiments instead of limiting the present application. As used in the description and the appended claims of the present application, “a”, “one” and “this” in a singular form are intended to include a plural form unless other situations are clearly indicated in the context.

It should be further understood that the term “and/or” used in the description and the appended claims of the present application refers to one or more of any combinations and all possible combinations in items relevantly listed and includes these combinations.

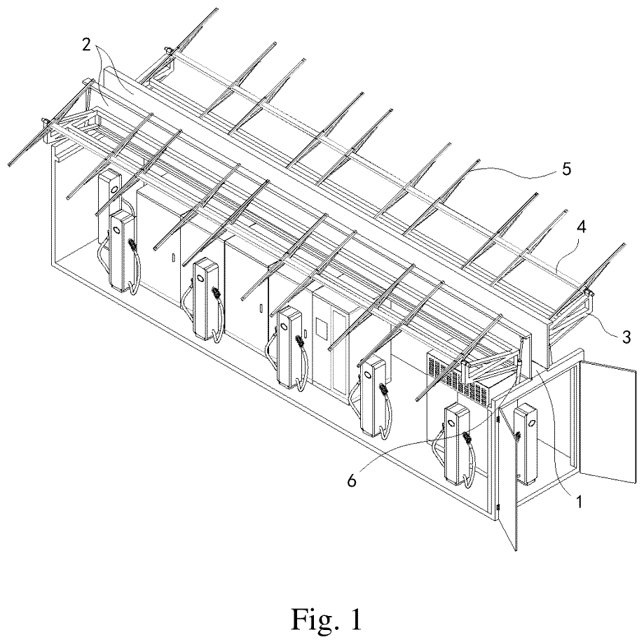

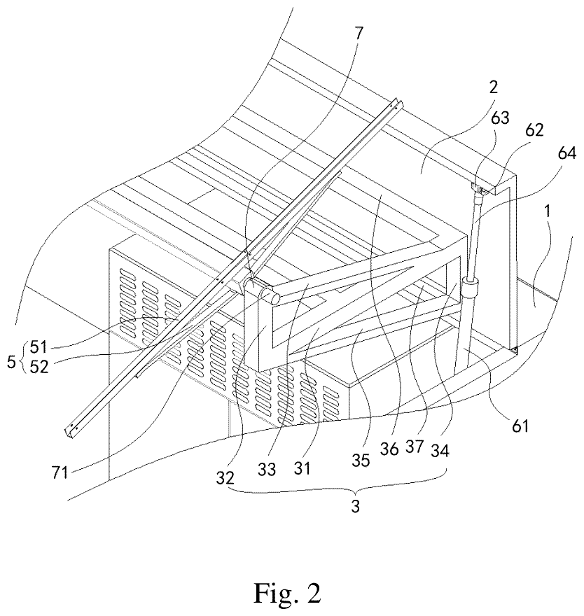

In the present embodiment, refer to FIG. 1 and FIG. 2, as shown in the figures, an embodiment of the present application provides a supporting assembly for solar panels applied to a container charging station, wherein the supporting assembly includes a top plate 1 and two cover plates 2 movably connected to the top plate 1; two sides in a long axis direction of the top plate 1 are respectively rotatably connected to sides of one of the cover plates 2; a side surface, facing away from the top plate 1, of each of the cover plates 2 is fixedly provided with a support 3; an end, away from the top plate 1, of the support 3 is provided with a strip-shaped supporting rod 4; a long side direction of the supporting rod 4 is parallel to a long side direction of the top plate 1; a plurality of fixed rods 5 are fixedly disposed in parallel on the supporting rod 4; long side directions of the fixed rods 5 are perpendicular to the long side direction of the supporting rod 4; the fixed rods 5 are fixedly provided with solar panels 10; a side surface, facing away from the top plate 1, of each of the cover plates 2 is further provided with a jacking mechanism 6, and the jacking mechanisms 6 are capable of driving the cover plates 2 to rotate along the sides; and ends of the supporting rods 4 are all fixedly connected to rotating shafts 7 disposed on the supports 3, the rotating shafts 7 on at least one end of the supporting rods 4 are driven by and connected to rotating motors 71, and the rotating motors 71 are capable of driving the supporting rods 4 to rotate and driving the solar panels 10 to adjust pitch angles.

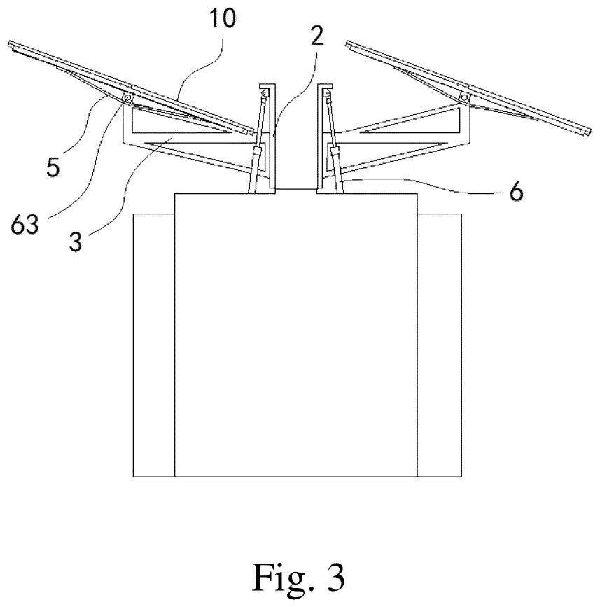

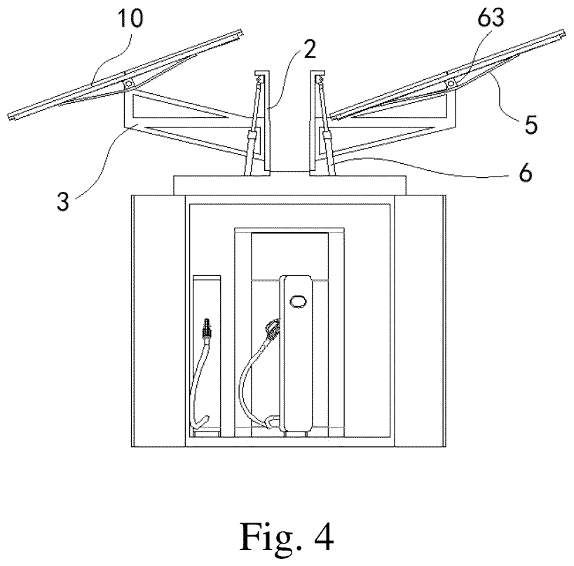

Each of two sides of the long axis direction of the top plate 1 is provided with one of the cover plates 2, and the cover plates 2 are both rotatably connected to the top plate 1. The jacking mechanisms 6 jack up the cover plates 2, or the gravities of the cover plates 2 are used as driving forces to make the cover plates 2 rotate along the sides thereof, that is, long sides connected between each of the cover plates 2 and the top plate 1 are the rotating shafts 7. The cover plates 2 can quickly flip under the drive of the jacking mechanisms 6, and thus, quick unfolding or intensive storage of the solar panels 10 is achieved. The solar panels 10 are fixedly disposed on the fixed rods 5, long axis directions of the fixed rods 5 can be adjusted by rotating the supporting rod 4, and then, the pitch angles of the solar panels 10 disposed on the fixed rods 5 are adjusted. Thus, the power generation efficiencies on unit area of the solar panels 10 can be increased for a solar irradiation direction. Inclination positions of the adjusted solar panels 10 during specific applications are shown as FIG. 3 and FIG. 4.

In a more specific embodiment, a cross section of the supporting rod 4 is rectangular. Specifically, each of the fixed rods 5 includes a horizontal fixed rod 51 fixedly disposed on a side surface of the supporting rod 4 and an inclined fixed rod 52 fixedly disposed on a side surface, opposite to the horizontal fixed rod 51, on the supporting rod 4; and two ends of the inclined fixed rod 52 are both fixedly connected to the horizontal fixed rod 51. The rotating shafts 7 on two ends of the supporting rod 4 are respectively driven by and connected to one of the rotating motors 71.

As shown in FIG. 2, by disposing the cross section of the supporting rod 4 to be rectangular, rotation of the fixed rods 5 relative to the supporting rod 4 during angular adjustment for the fixed rods 5 can be avoided, that is, the fixed rods 5 are more stably fixed on the supporting rod 4, and thus, inclination angles of the fixed rods 5 can be adjusted more precisely when the supporting rod 4 is driven to rotate, that is, the pitch angles of the solar panels 10 can be adjusted more precisely, and then, the power generation efficiencies on the unit area of the solar panels 10 are further increased.

In order to improve the stability between each of the fixed rods 5 and the supporting rod 4, each of the fixed rods 5 can also be set to consist of the horizontal fixed rod 51 and the inclined fixed rod 52, wherein the horizontal fixed rod 51 is of a straight rod-like structure, the inclined fixed rod 52 is bent in the middle and inclined at two ends, two ends of the inclined fixed rod 52 are both fixedly connected to the horizontal fixed rod 51, and a specific structure of the inclined fixed rod 52 is shown as FIG. 2: the supporting rod 4 is tightened from two sides by the horizontal fixed rod 51 and the inclined fixed rod 52, moreover, due to the rectangular section of the supporting rod 4, the horizontal fixed rod 51 and the inclined fixed rod 52 can be fixedly connected to the supporting rod 4 more stably under the action of a clamping force, and thus, the stability of fixed connection between each of the fixed rods 5 and the supporting rod 4 is further improved.

In order to further improve the rotation stability of the supporting rod 4, it is also possible that the rotating shafts 7 on two ends of the supporting rod 4 are respectively provided with the rotating motors 71 used for driving and connected to the rotating shafts 7, then, the rotating motors 71 on two ends simultaneously drive the supporting rod 4 to rotate in the same direction, so that the supporting rod 4 is more stable during rotation, and uneven rotation stresses on two ends of the supporting rod 4 is avoided.

In a more specific embodiment, an edge of a side, away from the top plate 1, of each of the cover plates 2 is turned and rolled to the supporting rod 4 to form a hemming with an “L”-shaped section. Specifically, the jacking mechanisms 6 include at least two jacking air cylinders 61 disposed on the cover plates 2; and a side surface of the hemming is provided with a connecting seat 62 in which a connecting shaft 63 is disposed, and an end of a jacking rod 64 in each of the jacking air cylinders 61 is rotatably connected to the connecting shaft 63. The edge of the side, away from the top plate 1 of each of the cover plates 2 can be provided with the hemming capable of turning and rolling towards a side facing the supporting rod 4, and then, the section of the cover plate 2 including the hemming is “L”-shaped, which has a specific set structure shown in FIG. 1 and FIG. 2. The hemmings can be used for protecting the solar panels 10, and after the storage of the solar panels 10 is completed, the sides of the solar panels are abutted against inner sides of the hemmings, and thus, the situation that the sides of the solar panels 10 are bumped to be damaged is avoided.

The side surface of the hemming can also be provided with the connecting seat 62 in which the connecting shaft 63 is disposed, the end of the jacking rod 64 in each of the jacking air cylinders 61 is rotatably connected to the connecting shaft 63, then, the end of the jacking rod 64 can rotate in an axial direction of the connecting shaft 63 under the drive of the jacking air cylinder 61, and at the same time, the jacking rod 64 jacks up each of the cover plates 2 or covers each of the cover plates 2 downwards.

In a more specific embodiment, the supports 3 include a plurality of first fulcrum bars 31 perpendicular to the side surfaces of the cover plates 2, second fulcrum bars 32 fixedly disposed on an end, away from the cover plates 2, of each of the first fulcrum bars 31 and perpendicular to the first fulcrum bars 31 and third fulcrum bars 33 for connecting the first fulcrum bars 31 and the second fulcrum bars 32; one of the first fulcrum bars 31 is combined with one of the corresponding second fulcrum bars 32 and one of the corresponding third fulcrum bars 33 to form a triangular structure; and the rotating shafts 7 are disposed on connections of the second fulcrum bars 32 and the third fulcrum bars 33. The supports 3 further include fourth fulcrum bars 34 fixedly disposed on an end, close to the cover plates 2, of each of the first fulcrum bars 31 and perpendicular to the first fulcrum bars 31 and fifth fulcrum bars 35 for connecting the fourth fulcrum bars 34 and the first fulcrum bars 31; one of the first fulcrum bars 31 is combined with one of the corresponding fourth fulcrum bars 34 and one of the corresponding fifth fulcrum bars 35 to form a triangular structure; and side surfaces of the fourth fulcrum bars 34 are fixedly connected to the side surfaces of the cover plates 2.

The supports 3 may be set to include the first fulcrum bars 31, the second fulcrum bars 32 and the third fulcrum bars 33, and the first fulcrum bars 31, the second fulcrum bars 32 and the third fulcrum bars 33 are combined to form the triangular structures; the first fulcrum bars 31 are perpendicular to the side surfaces of the cover plates 2, the rotating shafts 7 are disposed on the connections of the second fulcrum bars 32 and the third fulcrum bars 33, and then, the triangular structures can provide stable supporting forces for the rotating shafts 7 and the supporting rods 4 fixedly connected to the rotating shafts 7, that is, the triangular structures provide the stable supporting forces for the solar panels 10.

Furthermore, the supports 3 further include the fourth fulcrum bars 34 and the fifth fulcrum bars 35; the fourth fulcrum bars 34, the fifth fulcrum bars 35 and the first fulcrum bars 31 are combined to form the triangular structures, the side surfaces of the fourth fulcrum bars 34 are fixedly connected to the side surfaces of the cover plates 2, and the triangular structures enable the cover plates 2 to stably support the supports 3, thereby providing the stable supporting forces for the solar panels 10.

In order to further enable the supports 3 to be stably connected to the cover plates 2, the supports 3 further include first fixed cross bars 36 and second fixed cross bars 37, the first fixed cross bars 36 and the second fixed cross bars 37 are both disposed in parallel to the long axis direction of the top plate 1, moreover, the first fixed cross bars 36 and the second fixed cross bars 37 are respectively fixedly connected to two ends of the fourth fulcrum bars 34, and side surfaces of the first fixed cross bars 36 and side surfaces of the second fixed cross bars 37 are both fixedly connected to the side surfaces of the cover plates 2; and then, the first cross bars, the second cross bars and the plurality of fourth fulcrum bars 34 are combined to form one or more rectangular frame structures, the rectangular frame structures are stably connected to the cover plates 2, and thus, the stability of connection between the supports 3 and the cover plates 2 is ensured.

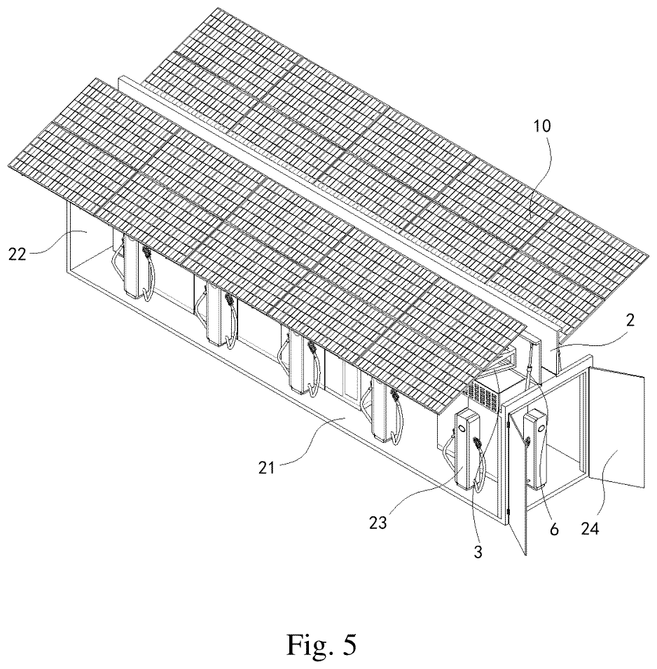

An embodiment of the present application further discloses a container charging station. As shown in FIG. 5, the container charging station includes the supporting assembly for the solar panels 10 in the above-mentioned embodiment and further includes a bottom plate 21 and supporting plates 22 disposed on two ends of the bottom plate 21; the bottom plate 21 is provided with a plurality of sets of charging piles 23; two ends of the top plate 1 are respectively fixedly connected to the two supporting plates 22; and when the jacking mechanisms 6 drive the cover plates 2 to rotate to ensure that each of the cover plates 2 is horizontal and each of the solar panels 10 is perpendicular, the bottom plate 21, the cover plates 2, the top plate 1 and the solar panels 10 are enclosed to form a closed box.

Specifically, the container charging station includes the plurality of sets of charging piles 23 disposed on the bottom plate 21, and therefore, when the cover plates 2 flip downwards to a horizontal direction and the solar panels 10 rotate to a vertical direction, the bottom plate 21, the cover plates 2, the top plate 1 and the solar panels 10 are enclosed to form the closed box, at the moment, the two sets of solar panels 10 are used as side surfaces of the closed box, and the charging piles 23, the solar panels 10, the jacking mechanisms 6 are all located in the closed box, so that intensive storage for all the components is achieved; and at the same time, the container charging station can be quickly transferred by a container transport vehicle, and thus, the deployment flexibility and efficiency of the container charging station are greatly improved, and the container charging station can be widely applied to a parking lot disposed in a city so as to quickly charge electric vehicles.

In a more specific embodiment, the supporting plate 22 on one end is provided with a box side door 24 which is openable and closeable. Or, the supporting plate 22 on one end is provided with the box side door 24 which has a specific set structure shown as FIG. 5, then, a user can enter the container charging station from the box side door 24, and thus, it is convenient to maintain and overhaul the container charging station.

Embodiments of the present application provide a supporting assembly for solar panels applied to a container charging station and the container charging station, wherein the supporting assembly includes a top plate and two cover plates movably connected to the top plate; two sides in a long axis direction of the top plate are respectively rotatably connected to sides of one of the cover plates; a side surface, facing away from the top plate, of each of the cover plates is fixedly provided with a support; an end, away from the top plate, of the support is provided with a strip-shaped supporting rod; a long side direction of the supporting rod is parallel to a long side direction of the top plate; a plurality of fixed rods are fixedly disposed in parallel on the supporting rod; long side directions of the fixed rods are perpendicular to the long side direction of the supporting rod; and the fixed rods are fixedly provided with solar panels. For the above-mentioned supporting assembly for the solar panels, the cover plates can be driven by jacking mechanisms to drive the supports to rotate, and thus, the solar panels are intensively stored, and the area occupied after the solar panels are stored is reduced; and after the solar panels are unfolded at the same time, rotating motors drive the supporting rods to rotate and drive the solar panels to adjust pitch angles, so that angles of the solar panels adapt to a solar irradiation angle, which maximizes power generation efficiencies of the solar panels.

Above descriptions are only specific implementations of the present application, but the protection scope of the present application is not limited thereto. All equivalent modifications or substitutions can be easily conceived by those skilled in the art within the technical scope disclosed by the present application, and these modifications or substitutions shall fall within the protection scope of the present application. Therefore, the protection scope of the present application should be subject to the protection scope defined in the claims.

1. A supporting assembly for solar panels applied to a container charging station, wherein the supporting assembly comprises a top plate and two cover plates movably connected to the top plate;
two sides in a long axis direction of the top plate are respectively rotatably connected to sides of one of the cover plates; a side surface, facing away from the top plate, of each of the cover plates is fixedly provided with a support;
an end, away from the top plate, of the support is provided with a strip-shaped supporting rod; a long side direction of the supporting rod is parallel to a long side direction of the top plate;
a plurality of fixed rods are fixedly disposed in parallel on the supporting rod; long side directions of the fixed rods are perpendicular to the long side direction of the supporting rod; the fixed rods are fixedly provided with solar panels;
a side surface, facing away from the top plate, of each of the cover plates is further provided with a jacking mechanism, and the jacking mechanisms are capable of driving the cover plates to rotate along the sides; and
ends of the supporting rods are all fixedly connected to rotating shafts disposed on the supports, the rotating shafts on at least one end of the supporting rods are driven by and connected to rotating motors, and the rotating motors are capable of driving the supporting rods to rotate and driving the solar panels to adjust pitch angles.

2. The supporting assembly for the solar panels applied to the container charging station of claim 1, wherein a cross section of the supporting rod is rectangular.

3. The supporting assembly for the solar panels applied to the container charging station of claim 2, wherein each of the fixed rods comprises a horizontal fixed rod fixedly disposed on a side surface of the supporting rod and an inclined fixed rod fixedly disposed on a side surface, opposite to the horizontal fixed rod, on the supporting rod; and two ends of the inclined fixed rod are both fixedly connected to the horizontal fixed rod.

4. The supporting assembly for the solar panels applied to the container charging station of claim 2, wherein the rotating shafts on two ends of the supporting rod are respectively driven by and connected to one of the rotating motors.

5. The supporting assembly for the solar panels applied to the container charging station of claim 1, wherein an edge of a side, away from the top plate, of each of the cover plates is turned and rolled to the supporting rod to form a hemming with an “L”-shaped section.

6. The supporting assembly for the solar panels applied to the container charging station of claim 5, wherein the jacking mechanisms comprise at least two jacking air cylinders disposed on the cover plates; and
a side surface of the hemming is provided with a connecting seat in which a connecting shaft is disposed, and an end of a jacking rod in each of the jacking air cylinders is rotatably connected to the connecting shaft.

7. The supporting assembly for the solar panels applied to the container charging station of claim 1, wherein the supports comprise a plurality of first fulcrum bars perpendicular to the side surfaces of the cover plates, second fulcrum bars fixedly disposed on an end, away from the cover plates, of each of the first fulcrum bars and perpendicular to the first fulcrum bars and third fulcrum bars for connecting the first fulcrum bars and the second fulcrum bars; one of the first fulcrum bars is combined with one of the corresponding second fulcrum bars and one of the corresponding third fulcrum bars to form a triangular structure; and
the rotating shafts are disposed on connections of the second fulcrum bars and the third fulcrum bars.

8. The supporting assembly for the solar panels applied to the container charging station of claim 7, wherein the supports further comprise fourth fulcrum bars fixedly disposed on an end, close to the cover plates, of each of the first fulcrum bars and perpendicular to the first fulcrum bars and fifth fulcrum bars for connecting the fourth fulcrum bars and the first fulcrum bars; one of the first fulcrum bars is combined with one of the corresponding fourth fulcrum bars and one of the corresponding fifth fulcrum bars to form a triangular structure; and
side surfaces of the fourth fulcrum bars are fixedly connected to the side surfaces of the cover plates.

9. A container charging station, wherein the container charging station comprises the supporting assembly for the solar panels of claim 1 and further comprises a bottom plate and supporting plates disposed on two ends of the bottom plate;
the bottom plate is provided with a plurality of sets of charging piles;
two ends of the top plate are respectively fixedly connected to the two supporting plates; and when the jacking mechanisms drive the cover plates to rotate to ensure that each of the cover plates is horizontal and each of the solar panels is perpendicular, the bottom plate, the cover plates, the top plate and the solar panels are enclosed to form a closed box.

10. The container charging station of claim 9, wherein the supporting plate on one end is provided with a box side door which is openable and closeable.
